(19) United States
(12) Patent Application Publication
(10) Pub. No.: US 2025/0251916 A1
(43) Pub. Date: Aug. 7, 2025

(54) QUERY RESOLUTION USING CODEBASE ANALYSIS AND GENERATIVE ARTIFICIAL INTELLIGENCE MODELS

(71) Applicant: AppLand Inc., Weston, MA (US)

(72) Inventors: Elizabeth Lawler, Weston, MA (US); Kevin Gilpin, Weston, MA (US); Dustin Byrne, Weston, MA (US)

(21) Appl. No.: 18/659,300

(22) Filed: May 9, 2024

Related U.S. Application Data
(60) Provisional application No. 63/548,800, filed on Feb. 1, 2024.

(51) Int. Cl. G06F 8/35; G06F 16/903

(52) U.S. Cl. CPC G06F 8/35; G06F 16/90335

(57) ABSTRACT

Technology for assisting software developers in searching, understanding, and identifying particular portions of codebases is provided herein. With the given tools, a user can submit a natural language query. The system will analyze the query and identify relevant portions of the codebase using a previously generated behavioral map of the codebase. Once relevant portions of the codebase are identified, the system generates a prompt for submission to a foundation model to elicit a response to the user's query. The response provided to the user will be complete and relevant to the user's particular codebase.

### CROSS REFERENCE TO RELATED APPLICATIONS

This application is related to U.S. patent application entitled “QUERY RESOLUTION USING CODEBASE ANALYSIS AND GENERATIVE ARTIFICIAL INTELLIGENCE MODELS,” Application No. 63/548,800, filed Feb. 1, 2024, the contents of which is incorporated by reference in its entirety for all purposes.

### TECHNICAL FIELD

Aspects of the disclosure are related to the field of computer software applications and, in particular, to responding to user queries about a codebase using codebase analysis and foundation model integration (i.e., generative artificial intelligence models).

### BACKGROUND

Generating and maintaining robust and reliable software requires testing the codebase to identify and address issues impacting the quality, performance, and security of the software. However, codebases can be very large, and identifying all potential issues, finding and understanding particular elements within a codebase, and the like can be challenging. Existing tools lack the intelligence to effectively respond to a user query for finding particular issues or behaviors within a codebase. Accordingly, tools to assist users with such searches and identification are needed.

### Overview

Technology is disclosed herein for resolving user queries relating to a codebase based on analysis of a behavioral model of the codebase via a foundation model integration in various implementations. In an implementation, a computing device receives a user query relating to a codebase in a user interface. The computing device analyzes a behavioral model of the codebase, the behavioral model representing a run-time behavior generated based on a run-time analysis of the codebase. To analyze the behavioral model, the computing device identifies content of the behavioral model that is associated with the user query and extracts code snippets from the codebase that are associated with the content. The computing device generates a prompt, including the model content and the extracted code snippets, which tasks the foundation model with generating an answer for the user query. The computing device causes display of the reply in the user interface.

In an implementation, the computing device identifies the content of the behavioral model by generating a keyword list based on the user query and searching the behavioral model for locations in the model based on the keyword list. In an implementation, to generate the keyword list, the computing device prompts the foundation model to generate the keyword list based on the user query. In an implementation, to search the behavioral model for the locations associated with the user query, the computing device performs a text similarity search of the behavioral model based on the keyword list.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational architecture for resolving queries relating to a codebase based on analysis of a behavioral model in an implementation.

FIG. 2 illustrates another operational architecture for resolving queries relating to a codebase based on analysis of a behavioral model in an implementation.

FIG. 3 illustrates a visual representation of a behavioral model of a codebase in an implementation.

FIG. 4 illustrates a process for resolving queries relating to a codebase based on analysis of a behavioral model in an implementation.

FIG. 5 illustrates an operational architecture for resolving queries relating to a codebase based on analysis of a behavioral model in an implementation.

FIG. 6 illustrates a workflow for resolving queries relating to a codebase based on analysis of a behavioral model in an implementation.

FIGS. 7A-7F illustrate a user experience of a system for resolving queries relating to a codebase based on analysis of a behavioral model in an implementation.

FIGS. 8A-8C illustrate a user experience of a system for resolving queries relating to a codebase based on analysis of a behavioral model in an implementation.

FIG. 9 illustrates a process for resolving queries relating to a codebase based on analysis of a behavioral model in an implementation.

FIG. 10 illustrates a computing system suitable for implementing the various operational environments, architectures, processes, scenarios, and sequences discussed below with respect to the other Figures.

### DETAILED DESCRIPTION

Various implementations are disclosed herein that describe technology for using behavioral models of codebases and generative artificial intelligence (i.e., foundation models) for better understanding the codebase, identifying particular behaviors of the codebase, and finding particular locations within a codebase quickly and efficiently. In an exemplary scenario, a user submits a natural language query relating to a codebase. The query may include questions related to the codebase behavior (e.g., where particular behaviors are exhibited, whether certain behaviors are performed in the codebase), to writing code or modifying existing code, to expanding a coding task into a detailed software change request, and so on. The system generates a prompt for submission to a foundation model (e.g., a large language model) which tasks the model with generating a resolution to the user query. To generate the prompt, the system captures contextual information from the codebase and the behavioral model of the codebase by which the foundation model can generate a response which is directly relevant to the codebase. The contextual information includes content (e.g., code paths and path locations, I/O events, SQL queries, HTTP server or client requests) from the behavioral model which is identified as relevant to the user query along with code snippets associated with the relevant model content. The contextual information may also include code snippets from the codebase which are separately identified as relevant to the user query.

To populate the prompt to the foundation model, the system may identify the relevant content from the behavioral model and the codebase using a keyword search of the behavioral model and of the source code of the codebase. The keyword search of the behavioral model yields matches (code paths, locations, I/O events, SQL queries, HTTP server or client requests) in the behavioral model which are relevant to the user query according to a list of keywords generated based on the user query. From the codebase, the system extracts code snippets which are associated with the relevant locations in the behavioral model. The system may also perform a keyword search of the codebase itself based on the keyword list to identify relevant content, e.g., relevant code sections. The system generates the prompt for the foundation model such that the prompt is designed to elicit a reply from the foundation model to answer the user query in the context of the information provided from the behavioral model and the codebase. By providing a highly contextualized prompt, the foundation model is able to generate a focused response that is specific to the codebase and which may be readily implemented by the user.

Upon submitting the prompt to the foundation model, a user interface hosted by the system receives and provides the reply. In some cases, the reply is validated before providing it via the user interface. To provide the reply, the reply may be visually displayed in a chat interface. In some embodiments, the reply is audibly provided. In some embodiments, coordination of the user interface visualization of the behavioral model, the codebase, or a combination are focused into particular locations for assisting the user with understanding the reply.

To obtain an AI-generated response which is specific to the codebase, the prompt to the foundation model is highly contextualized by the inclusion of selected portions of the behavioral model and selected snippets from the codebase. In a process of Retrieval Augmented Generation (RAG), the user query is initially submitted to the foundation model which is tasked with generating a list of search terms or keywords based on the query or relating to the query, such as a list of words, terms (e.g., coding terms), phrases, function definitions, identifiers, and so on. Upon receiving the keyword expansion list from the foundation model, the system performs a search, such as a Best Match 25 (BM25) search, of the behavioral model of the codebase to identify code paths and locations, I/O events, SQL queries, HTTP server/client requests, and so on in the behavioral model which are of particular relevance to the user query. Upon identifying the relevant locations in the behavioral model, the system then searches the portions of the codebase associated with the identified locations to identify code snippets which are relevant to the query based on the keyword list. Having identified relevant locations in the behavioral model and relevant code snippets in the codebase, this information is supplied to the foundation model to provide the context for the model to generate its reply. In this way, the model is able to generate a targeted response which is complete and specific to the user's codebase. Additionally, the content of the targeted response may be used by the system to surface visual representations of the relevant locations of the behavioral model and/or the relevant code snippets in the user interface when displaying the reply.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Example foundation models include GPT-3, GPT-4, and the like. Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics, and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as GPT-3 and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are creative, open-ended, and unpredictable.

Implementations of the technology described herein provide various advantages over available technologies. The combination of generative artificial intelligence with analysis of behavioral models gives software developers access to analysis and information about their codebase, codebase behavior under particular scenarios, and the like, which was previously unavailable. To understand this type of behavior for a codebase, a user would have to devote man-hours to searching and observing, and no prior automated system is available to provide such analysis. In addition, by providing selected portions of the codebase along with a representation of the codebase behavior (i.e., portions of the behavioral model) relating to the query in the prompt, the generative AI model can produce responses which are specific to the codebase and which the user can readily implement.

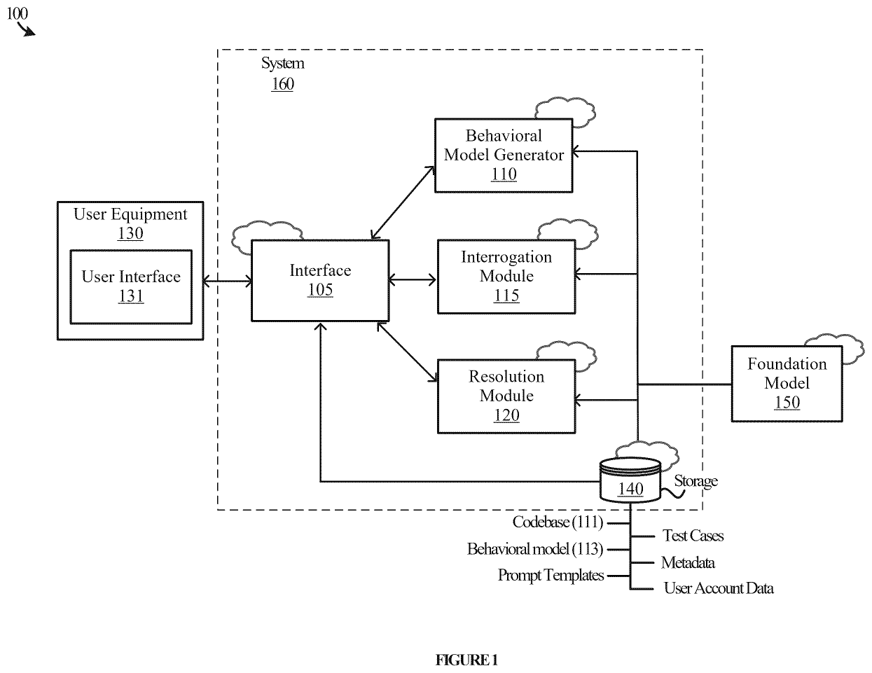

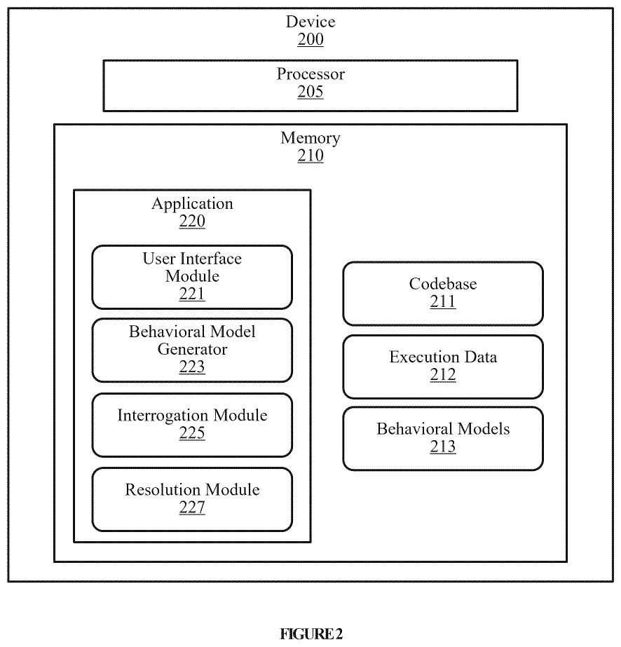

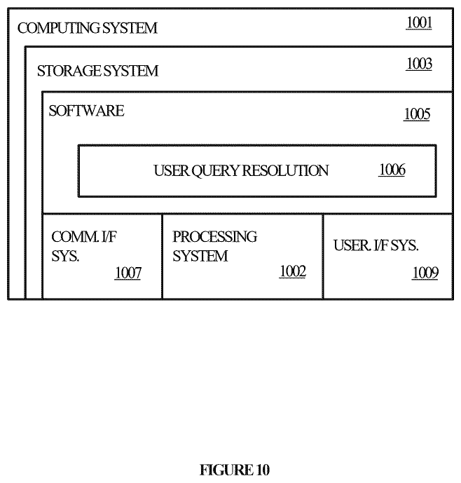

Turning to the figures, FIG. 1 illustrates operating environment 100 for a system for resolving queries based on an analysis of a codebase using behavioral models via a foundation model integration in an implementation. Operational environment 100 illustrates a cloud-based system to resolve queries served by a cloud-based service in an implementation. Operating environment 100 includes interface 105, behavioral model generator 110, interrogation module 115, resolution module 120, storage 140, foundation model 150, and user equipment 130. Operational environment 100 represents an exemplary environment in which process 1006 of FIG. 10 may be executed. A local implementation of a system for resolving queries is illustrated in FIG. 2, but the specific implementation of the functionality described herein does not depart from the scope of the description, whether performed via a local implementation, a cloud-based implementation, or a distributed (i.e., client-server) implementation, using a single computing system or multiple computing systems. Indeed, it may be appreciated that system 160 of FIG. 1 may operate in a localized implementation of a cloud-based environment, such as a private (e.g., subnet or on-premises) network of server computing devices or distributed across a hybrid environment of private and third-party servers.

System 160 includes interface 105, behavioral model generator 110, interrogation module 115, resolution module 120, and storage 140 for executing the functionality for analyzing codebases and resolving user queries related to a codebase.

Interface 105 represents a cloud-based interface to make online services accessible for interacting with a codebase, including generating behavioral models and querying system 160 in relation to the codebase. In an implementation, interface 105 makes the online services described herein accessible via user interface 131 on user equipment 130. Interface 105 may communicate with behavioral model generator 110, interrogation module 115, resolution module 120, as well as storage 140 to facilitate generating behavior models and resolving queries from the user for the user's codebase and to provide results to the user via user interface 131. Interface 105 may be software that executes on a cloud-based server. Interface 105 may execute on the same server or a different server than the server(s) executing the behavioral model generator 110, interrogation module 115, resolution module 120, and/or storage 140. Interface 105 may execute on a server or computing system accessible by behavioral model generator 110, interrogation module 115, resolution module 120, storage 140, or a combination thereof.

Behavioral model generator 110 generates a behavioral model of a codebase in operation. Behavioral model generator 110 monitors one or more run-time operations of user equipment 130 which executes the user's uploaded or stored codebase to generate trace files (e.g., JSON files) that include information about the behavior of the relevant portion of the codebase. In some embodiments, many trace files are generated related to a single codebase. For example, first behaviors (e.g., structured query language (SQL) connection behaviors) may be in a first trace file, while other behaviors (e.g., web connection behaviors) are maintained in another trace file. As another example, the codebase may be parsed into portions and the behaviors of each portion of the codebase are in a distinct trace file. In any case, the trace files represent the behavior of the codebase in operation. Behavioral model generator 110 may also make visual representations of the trace files available for visual consumption by the user. Examples of visual representations are included herein and generally include dependency maps, sequence diagrams, trace views, and flame graphs. Behavioral model generator 110 may include instructions executed by a processor on a computing system such as a server. In an implementation, behavioral model generator 110 may interact with storage 140 to source inputs for a behavioral model generation, such as codebase 111. Behavioral models generated by behavioral model generator 110 can be stored in storage 140, such as behavioral model 113. Behavioral model generator 110 may execute on the same server or a different server than the server(s) executing interrogation module 115, resolution module 120, and interface 105. Behavioral model generator 110 may execute on a server or computing system accessible by interface 105, interrogation module 115, resolution module 120, storage 140, or a combination thereof.

Interrogation module 115 interrogates a behavioral model, such as behavior model 113 generated by behavioral model generator 110, to identify portions (e.g., code paths, locations) within the behavioral model that are relevant to the user query. For example, if the user query requests information related to SQL queries, locations within behavior map 113 or particular trace files are identified for inclusion in the prompt as contextual information for resolving the user query.

Once the relevant code paths and locations within the behavioral model are identified, interrogation module 115 locates the corresponding portions of the codebase and extracts code snippets. Interrogation module 115 is used by interface 105 when a user query is submitted for resolving the user query in some embodiments. In some embodiments, resolution module 120 uses interrogation model 115 to coordinate a response to the user query. Interrogation module 115 may include instructions executed by a processor on a computing system such as a server. Interrogation module 115 may interact with storage 140 to obtain behavioral model 113, test cases, codebase 111, and the like. Interrogation module 115 may identify relevant portions of the behavior model based on parsing the user query and determining an intent of the user query. In some embodiments interrogation module 115 may utilize an AI engine or model, e.g., foundation model 150, to perform natural language processing, intent determination, and the like. Interrogation module 115 may execute on a server or computing system accessible by interface 105, behavioral model generator 110, resolution module 120, storage 140, or a combination thereof. Interrogation module 115 may execute on the same server or a different server than the server(s) executing behavioral model generator 110, resolution module 120, and interface 105.

After the relevant information from the behavior model and the codebase is identified, interrogation module 115 communicates the identified information to resolution module 120. Resolution module 120 generates prompts for submission to foundation model 150. For example, resolution module 120 configures an initial prompt to foundation model 150 which tasks the model with generating a keyword expansion list by which to search for content pertinent to the query. Resolution module 120 may also configure prompts for foundation model 150 to generate a response to the query based on the relevant information of the behavioral model and the identified code snippets to which the user query pertains. In some embodiments, the prompt may be configured using a prompt template that includes the user query or some revised version of the user query generated by resolution module 120 based on the intent of the query. In some embodiments, the prompt may specify rules or instructions about how the model should generate its response, such as a desired format for the reply (e.g., as a JavaScript Object Notation (JSON) object). Resolution module 120 submits the prompt to foundation model 150 and receives a reply to the prompt which includes a response to the user query. Resolution module 120 may include instructions executed by a processor on a computing system such as a server. Resolution module 120 may interact with storage 140 to store the identified solution or metadata associated with the corresponding issue and solution. Resolution module 120 may execute on a server or computing system accessible by interface 105, behavioral model generator 110, interrogation module 115, storage 140, or a combination thereof. Resolution module 120 may execute on the same server or a different server than the server(s) executing behavioral model generator 110, interrogation module 115, and interface 105.

Foundation model 150 is representative of one or more computing services capable of hosting a foundation model and communicating with resolution module 120. Foundation model 150 may be implemented in the context of one or more server computers co-located or distributed across one or more data centers. Foundation model 150 is representative of a deep learning AI model, such as BERT, ERNIE, T5, XLNet, or of a generative pretrained transformer (GPT) computing architecture, such as GPT-3®, GPT-3.5, ChatGPT®, or GPT-4. Foundation model 150 communicates with resolution module 120, including receiving natural language prompts and returning output, including computer code and natural language text, according to the prompt based on its training. Resolution module 120 communicates with foundation model 150 via one or more internets and intranets, the Internet, wired or wireless networks, local area networks (LANs), wide area networks (WANs), and any other type of network or combination thereof.

Storage 140 interacts with all the online services of operating environment 100 and includes a database of memory housing relevant data for use by operating environment 100. For example, storage 140 may include codebase 111, behavioral model 113, prompt templates, test cases, metadata, user account data, and the like. Codebase 111 may be uploaded from interface 105 by a user. Behavioral model 113 may be generated by behavioral model generator 110 and may include trace files as well as generated visualizations of the behavior in, for example, flame graphs, dependency models, and the like. Test cases may be used by behavioral model generator 110 to generate behavioral models. In other words, behavioral model generator 110 may execute test scripts and record the execution by generating the trace files for analyzing how the codebase 111 behaves. Metadata may include any metadata stored related to the codebase, behavioral models, prompt templates, test cases, and the like. In some implementations, users repeatedly interact with operating environment 100 via user interface 131 to execute, debug, and analyze their codebases. For example, a user, such as development operations engineer, may be developing an application that requires numerous libraries to run. Throughout the development of this example application, the development operations engineer may use a debugger to identify complications while the application is developed. Multiple executions of the behavioral model generator 110 generate data, and storage 140 can store previous user account data including copies of versions of the codebase 111 and behavior model 113. Further, resolution module 120 may optimize its performance based on past interactions with the user. In some embodiments, data regarding each run of the behavioral model generator 110, interrogation module 115, resolution module 120, or any combination of them may be stored in storage 140 temporarily or permanently.

Codebase 111 represents a source code codebase for a software application. Software applications represented by codebase 111 can include locally installed applications on a personal computer, locally installed applications on a server, applications served from a cloud, web applications, apps for installation on a mobile device, or the like. Codebase 111 may be written in any coding language, such as, for example JAVA, RUBY, C, C++, FORTRAN, PYTHON, JAVASCRIPT, MATLAB, or the like. In some implementations, codebase 111 may be accessed by interface 105 or other elements of operational environment 100 from storage 140 but may also be accessed from user equipment 130.

Behavioral model 113 is representative of a behavioral model generated based on a run-time analysis of a codebase, such as codebase 111. Behavioral model 113 includes operational details and events observed while executing codebase 111 during the run-time analysis. Behavioral model 113 may include elements that were generated based on recordings, trace files, error logs, diagnostic logs, and the like. Behavioral model 113 can also include data by which visual depictions or representations of the codebase, such as sequence diagrams of processes performed by the codebase, may be generated and displayed in user interface 131. Locations of the behavioral model may be elements in the model's trace files which correspond to portions of the codebase, such as blocks of code (e.g., modules, functions, data objects, etc.), interfaces, dependencies, flows, events, and so on.

User equipment 130 includes user interface 131. A user may utilize user interface 131 for query resolution based on an analysis of a behavioral model, such as behavioral model 113, of an uploaded or stored codebase. User interface 131 may be included in a software application installed on user equipment 130 or accessible via a web browser. User equipment 130 communicates with interface 105 to share data between the user and the online services of the system of operational environment 100.

In a brief exemplary operational scenario, a user wishes to analyze behavior of the codebase 111 and identify locations of a specific behavior. The user accesses user equipment 130 and interacts with user interface 131 including submitting natural language input to interface 105. Via user interface 131, the user may upload a codebase or access a previously stored codebase for analysis; for the sake of illustration, it will be assumed that the user wishes to access codebase 111 stored by storage 140. User interface 131 communicates with interface 105 to request analysis of codebase 111 based on the user input received via user interface 131. Interface 105 tasks behavioral model generator 110 with generating a behavioral model of codebase 111. Alternatively, if a behavioral model for codebase 111 already exists (e.g., from a prior run of the behavioral model generator 110 for that codebase), the previously stored behavioral model may be accessed from storage 140. For the sake of illustration, it will be assumed that the run-time analysis and AI-based resolution will be performed with respect to behavioral model 113. Interface 105 may make a visual representation of behavioral model 113 for codebase 111 accessible to the user via user interface 131.

Continuing the exemplary scenario, the user submits a natural language query regarding the behavior of the codebase 111 via user interface 131. Interface 105 passes the query to resolution module 120 for solving. Resolution module 120 prompts foundation model 150 to generate a keyword search list based on the user query. Resolution module 120 then passes an AI-generated list of keywords received from foundation model 150 to interrogation module 115. Interrogation module 115 identifies data files of behavioral model 113, such as trace files, which are associated with the user query based on their relevance to the list of keywords. Interrogation module 115 further identifies within codebase 111 specific locations associated with the relevant data files or portions of the data files and identifies relevant code snippets. In some scenarios, interrogation module 115 generates a stripped-down version of the relevant data files from which extraneous information has been removed. Interrogation module 115 passes the relevant code snippets and the relevant portions of the behavioral model (e.g., data files or stripped-down data files) to resolution module 120. Resolution module 120 generates a prompt for submission to foundation model 150 designed to elicit a response to the user query.

To generate the prompt for submission to the foundation model, resolution module 120 may obtain a prompt template from storage 140. Resolution module populates the prompt with the relevant code snippets and the relevant portions of the behavioral model. The prompt may also include the user query or a revised version of the user query such that the question presented by the user is submitted to foundation model 150 in a way to elicit the desired response. For example, if the user query submitted was “does this codebase include inefficient SQL queries?” the prompt may include a revised version of the query: “Identify within the included code snippets inefficiencies related to SQL queries. Please provide the particular code portions and database names in the response.”

Upon submitting the prompt to foundation model 150, resolution module 120 receives a reply to the prompt including a response to the user query. Interface 105 provides the response to user interface 131 for display, such as in a chat pane where the query was received. The reply may include particular sections of codebase 111 provided in the relevant code snippets, particular locations in the behavioral model data files, and the like. Resolution module 120 may parse the response from foundation model 150 to display the data file locations or code snippets in association with displaying the reply. In some scenarios, the system appends hyperlinks to the displayed reply to surface a visual presentation of a portions of the behavioral model or the codebase that is relevant to the reply.

FIG. 2 illustrates computing device 200 for resolving queries based on an AI-generated analysis of a codebase in a local implementation for downloadable implementations. Computing device 200, of which computing system 1001 of FIG. 10 is representative, includes a processing unit such as processor 205 responsible for reading non-transitory computer-readable storage media such as memory 210. (Computing system 1001 of FIG. 10 depicts additional functionality of a standard computing device excluded from device 200 for case of description.) Computing device 200 may be any computing device that can download and execute software for identifying and resolving run-time complications. For example, computing device 200 may be a server, personal computer, laptop, server farm, distributed computing environment, or the like.

Memory 210 includes codebase 211, execution data, 212, behavioral models 213, and application 220. Codebase 211 may be the same as codebase 111 of FIG. 1. Codebase 211 may be user uploaded, stored on computing device 200 for testing, or otherwise supplied to device 200. Codebase 211 may be collected using a user interface of application 220. Application 220 performs the functions to resolve a user query related to codebase 211 and provide a response.

Execution data 212 represents operational definitions that specify the behavior of elements of a specific coding language (e.g., JAVA, RUBY, etc.). For example, execution data 212 may include test cases for executing codebase 211, information for generating synthetic traffic, data for defining code blocks for specific code block execution, data for defining specific processes for execution, and the like.

Behavioral models 213 represents a run-time analysis of codebase 211 and includes operational details and events observed while executing codebase 211. Behavioral models 213 may include elements that were generated based on recordings, trace files, error logs, diagnostic logs, and the like. Behavioral models 213 are generated by behavioral model generator 223.

Application 220 may provide a user interface based on user interface module 221. The user may, for example, provide access to codebase 211 for analysis. Application 220 includes user interface module 221, behavioral model generator 223, interrogation module 225, and resolution module 227. In an implementation, a user interacts with computing device 200 through user interface module 221. The user may provide access to codebase 211 using the user interface. Codebase 211 may be stored in memory 210 if not previously stored. Accordingly, processor 205 may execute codebase 211 when in memory 210. Processor 205 may further execute application 220 to generate and interrogate a behavioral model of codebase 211 and provide responses to user queries as described in more detail below.

Behavioral model generator 223 is substantially the same as behavioral model generator 110, interrogation module 225 is substantially the same as interrogation module 115, and resolution module 227 is substantially the same as resolution module 120. Accordingly, the user may install and use a local implementation of the functionality discussed above with respect to FIG. 1. The resolution module 227 submits the prompt to foundation model 150, which is hosted as a cloud-based service.

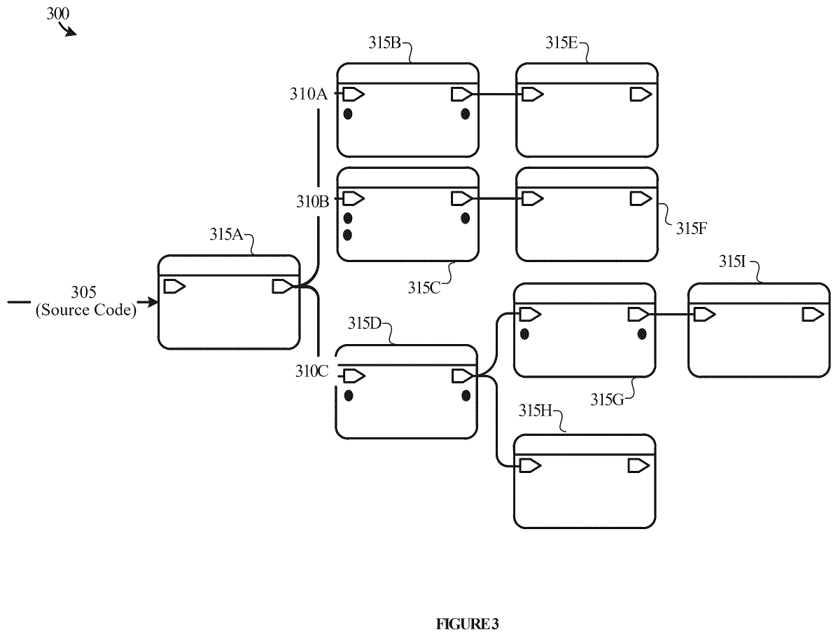

FIG. 3 illustrates visual depiction 300 which is representative of a visual depiction of a behavioral model or portion thereof in an implementation. Visual depiction 300 is a visual representation of the behavioral model of the source code of codebase 305. Codebase 305 is representative of codebase 111 of FIG. 1 or other codebases used to generate behavioral models. The behavioral model is generated based on a run-time operation and analysis of a codebase 305. Codebase 305 may be source code in any coding language. Examples of codebase 305 include but are not limited to web applications, locally installed applications, and applications served from a cloud. Visual depiction 300 depicts an example of a behavioral model that may be created by a generation module, such behavioral model generators 110 or 223 of FIGS. 1 and 2, respectively.

In some implementations, codebase 305 is submitted to a generation module that generates the corresponding behavioral model that represents the run-time operation of the codebase 305. The generation module may exhaustively probe the codebase 305 to identify parameters, connection points, and the like to ensure a thorough representation of the codebase 305 in operation. The behavioral model generated by the generation module may include information by which other diagrams, such as sequence diagrams, can be rendered. The behavioral model may also include information by which a prompt to a foundation model concerning a portion of the codebase can be populated, such as relationships between blocks of code in codebase 305.

The behavioral model of codebase 305 may be stored as a visual depiction, such as visual depiction 300, or may instead be stored as data representing the behavior of the codebase 305 including connection information, operational paths (e.g., code paths), functional categories, and the like. As shown in visual depiction 300, operational paths 310A, 310B, and 310C represent the path of the codebase in operation. More specifically, operational paths 310A, 310B, and 310C detail the execution of codebase 305 functions in real-time. The code blocks 315A, 315B, 315C, 315D, 315E, 315F, 315G, 315H, 315I represent data transformations or other operations that include one or more inputs from operational paths 310 and one or more outputs to other operational paths 310.

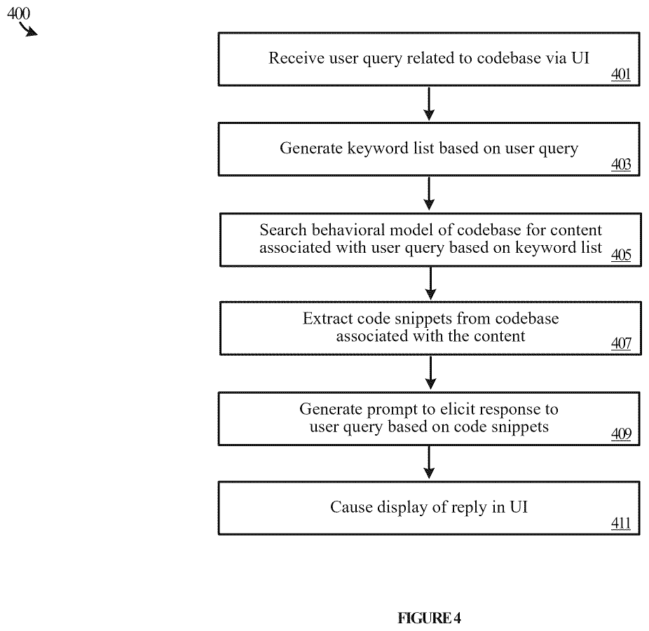

FIG. 4 illustrates a method for resolving queries based on an AI-generated analysis of a codebase in an implementation, herein referred to as process 400. Process 400 may be implemented in program instructions in the context of any of the software applications, modules, components, or other such elements of one or more computing devices. The program instructions direct a system comprising the computing device(s) to operate as follows.

In various implementations, a system for codebase analysis executes a behavioral model generator, such as behavioral model generator 110 of FIG. 1, to generate a behavioral model of a codebase, such as behavioral model 113 of codebase 111. The behavioral model captures threads, processes, and other execution flows of the codebase in trace files for analysis of the codebase, such as resolution of run-time complications, resolution of user queries relating to the codebase, and the like. The system communicates with an AI model, such as a large language model or other type of foundation model, to receive AI-generated responses to natural language queries about the codebase from a user, such as a client associated with the codebase. The system hosts a user interface by which to display visual representations of the codebase and the behavioral model and to receive user input such as user queries about the codebase.

In process 400, a user submits a natural language query about the codebase in a user interface of a computing device displaying a user experience for the system (step 401). In some cases, the user experience may include a chat pane by which to receive a query keyed in (or spoken by the user and transcribed by speech-to-text engine) from the user. The query may be a general inquiry about the operation of the codebase, or the query may be directed to a specific service or functionality of the codebase. For example, the user may select a portion of the codebase or a graphical element (representing an element of the codebase) in a visual representation of the behavioral model, then enter a query about the selected item. The user query may be a request for an explanation of code behavior, for example, to pinpoint a behavioral issue, or a request to generate code to perform some task. In some cases, the user may request that a coding task be expanded into a more formally defined and detailed software change request. In any case, the request may be augmented with contextual information per the steps of process 400 to obtain a highly relevant response from the AI model.

Upon receiving the query, the system generates a keyword list based on the user query (step 403). In an implementation, the system generates an initial prompt which tasks the AI model with generating a keyword expansion list based on the user query. The initial prompt may specify that the list should include words, terms, phrases, identifiers, or coding terminology by which a search can be performed of a behavioral model of a codebase to identify locations in the model or codebase which are relevant to the query. The initial prompt may specify that the model is to identify keywords from the query but to also identify synonymous or related keywords. The initial prompt may specify that the model is to return an enumerated list of keywords in a particular format. In some scenarios, the AI model may be fine-tuned to generate keyword lists based on natural language queries. Based on the initial prompt, the AI model returns a list of keywords relating to the query to the system.

The system searches the behavioral model of the codebase for content associated with the user query based on the keyword list (step 405). In an implementation, to search the behavioral model based on the keyword list for content associated with the user query, the system performs a text search, such as a Best Match 25 (BM25) search, of the trace files to identify content matches (e.g., code paths, locations, input/output (I/O) events, SQL queries, HTTP server/client requests) of the behavioral model which are most relevant to the query (e.g., based on the number of “hits”). Having identified relevant code paths, the system then searches the identified paths to identify particular locations which are relevant to the user query. In various implementations, to search the behavioral model for relevant code paths and relevant path locations, the system performs BM25 searches of the code paths or trace files of the behavioral model. For example, the system may execute a search engine which scores the code paths according to the relevance of the paths to the keyword list. The relevance score of a given code path generated by the search engine is based on the frequency of terms of the keyword list while accounting for code path length and rarity of the terms across all the searched code paths. Using a BM25 search, the system identifies relevant code paths based on the keyword list. The code paths may be ordered according to their respective relevance scores, and a cutoff or threshold value may be used to filter out the lower-scoring code paths.

Having identified the most relevant code paths, the system may perform a second similarity search (e.g., another BM25 search) of the most relevant code paths to identify locations in the code paths which are highly relevant to the keyword list. With locations scored according to relevance, the results may be screened to identify the locations of the behavioral model that are the most relevant to the user query. In this way, the model content associated with the user query, comprising code paths and locations of the behavioral model that are most relevant to the user query, is identified.

In some cases, the system may search the behavioral model based on vector or cosine similarity calculations between the keyword list and the trace files of behavioral model. To perform a search based on vector similarity, the list of keywords is tokenized, and vector representations of the tokenized keywords are generated. An aggregate vector representation of the tokenized keywords is generated (e.g., by taking the mean of the individual keyword token vectors). Next, the trace files of the behavioral model are tokenized, and vector representations of the tokenized files are generated. For example, a vector may be generated for each trace file of the behavioral model. A cosine similarity is then calculated between the aggregate keyword vector and each of the vectors of the trace files. The cosine similarity values may be ordered to identify the vectors of the trace files which are closest to (i.e., most similar to) the aggregate keyword vector. A cutoff or threshold value may be used to filter out vectors of the trace files which are too distant from the aggregate keyword vector (e.g., vector representations for which similarity values are below 0.5 are discarded). Thus, locations in the behavioral model (e.g., trace files) that are most similar to the keyword list, and thus most relevant to the user query, are identified.

To avoid exceeding a token limit of AI model and to avoid confusing the model with too much information, in some scenarios, the system generates stripped-down versions of the relevant code paths or trace files which include the relevant code paths which were identified from the similarity search by removing extraneous content from the files, i.e., content which is unrelated to the query. For example, based on the keyword search of the relevant code paths or trace files, the system may remove low-scoring portions of the trace file or code path content as being unrelated to the query. What remains in the stripped-down trace files is a more concise representation of the codebase which maps the relevant interaction or sequence of functionalities of the codebase. This more concise representation allows the AI model to generate a more focused and more detailed response to the user query.

In some scenarios, similarity searches of the behavioral model based on the keyword list may yield code paths or trace files with equivalent scores. To augment or further refine the similarity searches, the system may differentiate the search results based on the relevance of the code paths and/or path locations to run-time data or run-time code paths.

Continuing with process 400, the system extracts code snippets from the codebase based on the identified content of the behavioral model (step 407). In an implementation, the code paths and locations of the code paths of the behavioral model which are identified as being relevant to the user query are associated with specific sections or snippets of the codebase. For example, the relevant locations may include line numbers corresponding to lines in the source code which the location represents. To identify and extract code snippets that are relevant to the user query, the snippets of the codebase that are associated with the relevant code paths, path locations, and/or trace files (or stripped-down trace files) are searched based on the keyword list. In some cases, the system performs a text search (e.g., a BM25 search) of the code snippets based on the keyword expansion list to identify the snippets which are relevant to the user query. Here, too, results of the text search of the codebase may be further differentiated based on the relevance of the results to identified content of the behavioral model. Alternatively, the system may perform a vector similarity search between the aggregate keyword vector and vector representations generated for the (tokenized) code snippets based on the most relevant code snippets yielding the highest similarity scores. Thus, the code snippets which are deemed relevant to the user query based on the vector similarity values are then captured for use in prompting the AI model.

In the next step, the system generates a prompt for the AI model to elicit a response to the user query based on the locations of the behavioral model and the code snippets (step 409). To generate the prompt, in an implementation, the prompt is configured based on a template including rules or instructions for how the AI model is to generate its response and fields for contextual information as well as the user query (or information relating to an intent of the user query). The system populates the prompt template with contextual information including the code paths and locations of the behavioral model which were identified in the similarity search, such as the trace files or stripped-down trace files that were identified based on the similarity search, and the relevant code snippets identified from the trace files. The prompt tasks the AI model with generating its response to the user query based on the contextual information. The prompt template may also include any preceding exchange of information (or conversation) between the system or user and the AI model which relates to the user query. For example, the user may submit a question about implementing some aspect of a response in a follow-on query to the AI model.

Upon receiving a response to the prompt from the AI model, the system causes display of the generated reply in the user interface (step 411). In an implementation, the reply is surfaced in a chat pane in the user interface where the user may engage in a turn-based conversation with the AI model. In some implementations, prior to surfacing the reply, the system parses the response to determine a visual representation of the behavioral model (e.g., dependency map, sequence listing, trace view) or codebase to display in association with displaying the reply. For example, the prompt may task the AI model with suggesting a visual representation of the behavioral model or the codebase that is most related to the reply or that would be helpful to the user in understanding the reply. The system then displays the suggested content alongside the chat pane. In some cases, the system may configure and display hyperlinks to locations of the behavioral model or the codebase relating to the reply. For example, where the AI-generated reply includes a list of instructions to accomplish a task, each step of the task may include hyperlink to a location in the codebase where the step is to be performed.

In some implementations of process 400, the system initially classifies the user query according to a query type, such as a general inquiry about the codebase (e.g., without reference to a specific functionality) or a targeted inquiry about a particular functionality. When the user query is deemed to be a general inquiry, the system may submit the prompt to the AI model including the locations of the behavioral model (e.g., trace files) identified based on the similarity search but without identifying code snippets based on those locations. For example, if the user submits an inquiry about the overall architecture of the codebase, the query may be classified such that code snippets are not to be identified and supplied in the prompt, and the AI model may be tasked with generating its response based on the locations in the behavioral model identified as pertinent to the query. On the other hand, if the user submits an inquiry relating to resolving a runtime complication, the query may be classified such that more detailed contextual information (i.e., relevant code snippets) are to be provided in the prompt.

In a brief illustration of process 400, a user may submit a query concerning a codebase for a web-based application: “How do I add Captcha to the login?” The system generates a prompt to a foundation model for a resolution to the user query. To generate the prompt, the system captures contextual information from the codebase and the behavioral model of the codebase on which the foundation model can generate its response. The contextual information includes code paths and path locations from the behavioral model which are relevant to the user query along with code snippets associated with the code paths and path locations. The contextual information may also include code snippets from the codebase which are separately identified as relevant to the user query. The system may identify relevant content from the behavioral model and the codebase using a search engine of the trace files of the behavioral model and the source code of the codebase.

To capture the contextual information for the prompt, the system sends the query to the AI model to receive a keyword expansion list by which to perform various text searches for relevant content in the codebase and the behavioral model. The AI model returns a list including words and terms relating to the query which might include terms such as “login,” “Captcha,” “username,” “password,” “authenticateUser,” “checkCredentials,” “isLoggedIn,” “userSession,” “loginAttempts,” and so on. The trace files of the behavioral model are searched against the keyword expansion list (e.g., using a text similarity search) to identify the relevant trace files, including relevant code paths and path locations. With the relevant trace files identified, stripped-down versions of the trace files are generated by stripping out extraneous information (e.g., boilerplate, unrelated functionality, etc.). Based on the stripped-down trace files, portions of the codebase corresponding to the relevant code paths and/or path locations are then identified for inclusion in the prompt. The system also searches the codebase against the keyword expansion list to identify snippets of code which are relevant to the query. The stripped-down versions of the trace files along with the identified snippets of code and the user query are submitted to the AI model in a prompt which tasks the model with generating a response to the query based on the supplied content. The response received from the AI model is then configured for display in the user interface and the system directs the user interface to display a visual representation of the relevant locations of the behavioral model and/or the relevant sections of the codebase alongside the response.

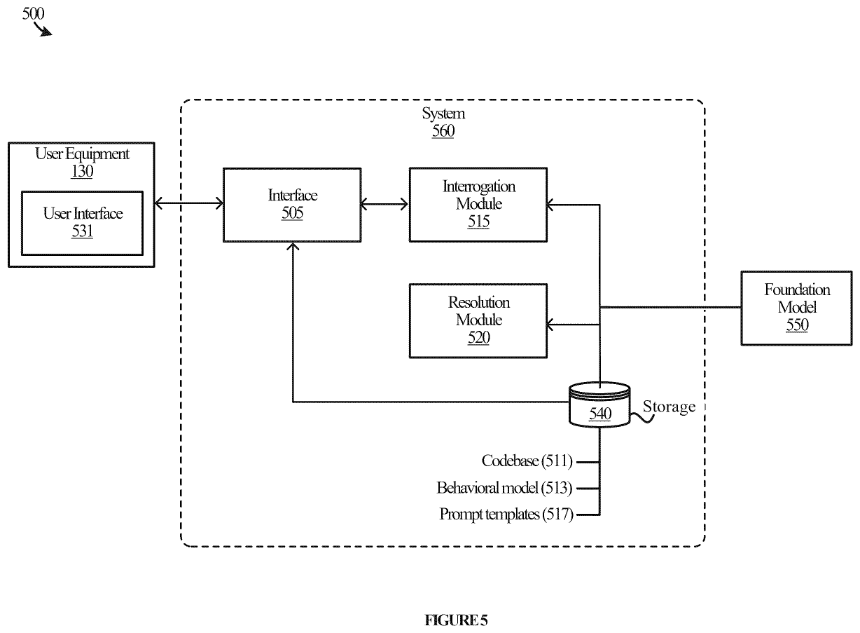

Turning now to FIG. 5, operational scenario 500 depicts system 560 for resolving queries relating to a codebase based on AI-generated analysis of a behavioral model of the codebase in an implementation. System 560, of which system 160 of FIG. 1 is representative, may be implemented locally on one or more user computing devices, such as user equipment 530, or system 560 may be a cloud-based system hosted by one or more server computing devices which communicates with user equipment 530 via one or more wired/wireless networks.

In operational scenario 500, user interface 531 is hosted on user equipment 530, of which user interface 131 and user equipment 130 are representative. User equipment 530 communicates with system 560 via interface 505. User interface 531 displays a user experience (not shown) by which a user can interact with system 560 with respect to codebase 511. System 560 includes interrogation module 515 and resolution module 520, of which interrogation module 115 and resolution module 120 are representative. (System 560 may include other components, such as a behavioral model generator, which are not shown for case of description.) Resolution module 520 communicates with foundation model 550, such as via an application programming interface (API) hosted by foundation model 550 of which foundation model 150 is representative. System 560 also includes storage 540, of which storage 140 is representative, for storing codebase 511, behavioral model 513 of codebase 511, and prompt templates 517. In an implementation, resolution module 520 configures prompts for foundation model 550 based on a template selected from among prompt templates 517.

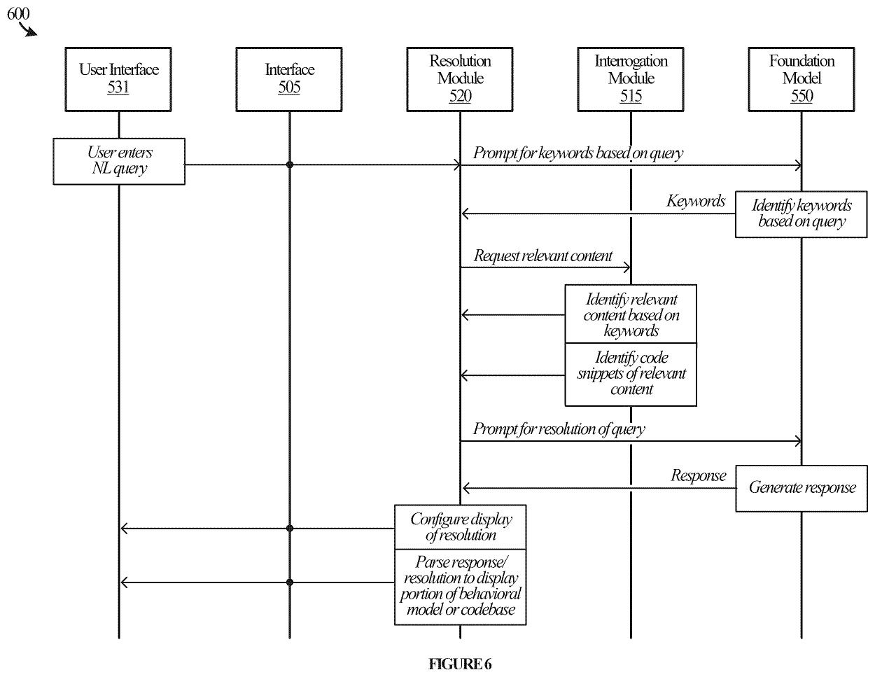

FIG. 6 illustrates workflow 600 for resolving queries relating to a codebase based on analysis of a behavioral model of the codebase in an implementation, referring to elements of operational scenario 500. In workflow 600, a user submits (e.g., keys in or speaks) a natural language query regarding codebase 511 to system 560. The query is received by interface 505 which forwards the query to resolution module 520. Resolution module 520 generates a prompt for foundation model 550 to identify keywords (e.g., words, phrases, coding terms, identifiers) by which behavioral model 513 can be searched. Foundation model 550 returns a set of one or more keywords based on the query to resolution module 520.

Upon receiving the set of keywords, resolution module 520 sends a request to interrogation module 515 for content (e.g., code paths, path locations, trace files) of the behavioral model that is relevant to the query based on the set of keywords. Interrogation module 515 performs a text search of behavioral model 513 to identify content in the model which is relevant to the user query. Interrogation module 515 also identifies snippets of the codebase related to the query according to a correspondence to the relevant content of the behavioral model and/or based on a text search of the codebase itself. In some scenarios, the relevant model content includes trace files of the model which in turn include the relevant code paths.

Having received the relevant behavioral model content and relevant code snippets from interrogation module 515, resolution module 520 submits a prompt to foundation model 550 which tasks the model with generating a response to the query based on the contextual information (the relevant model content and the relevant code snippets) supplied in the prompt. Foundation model 550 generates and returns a response to the prompt to resolution module 520.

When resolution module 520 receives a response to the prompt, it configures a display of the response for display in user interface 531. For example, resolution module 520 may format the response so that any lines of code in the response are configured with graphical elements to be copied and pasted into the codebase. Resolution module 520 also parses the response to display portions of the behavioral model or codebase to display in association with the response. For example, resolution module 520 may identify a type of visual representation of behavioral model 513 (e.g., sequence diagram, trace view, flame graphs) to display in association with the response. Resolution module 520 may also identify a section of the codebase to which the response refers for display alongside the response. In some cases, resolution module 520 may configure hyperlinks to relevant locations in behavioral model 513 or codebase 511 so the user can easily navigate to those locations.

In some scenarios of workflow 600, when the user query is first received, resolution module 520 may perform an initial classification of the user query with regard to what types of contextual information will be needed or used by foundation model 550 to generate a comprehensive, detailed response to the query. When the query is classified as one which may require a modification to the codebase, interrogation module 515 may perform an additional search to extract relevant code snippets from the relevant trace files. Resolution module 520 may classify the query as one for which code snippets should be provided for contextual information in responding to the query. If, however, the query is a broader inquiry or is vague in its intent, such as requesting a high-level narrative which describes the operation of the codebase, interrogation module 515 may identify and return the relevant trace files of behavioral model 513 to resolution module 520 without also identifying relevant code snippets.

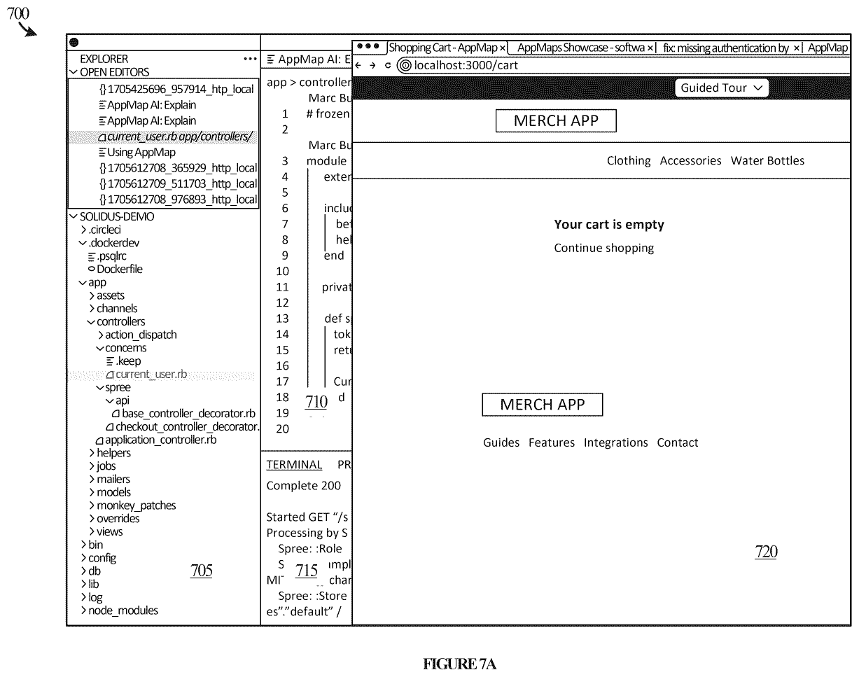

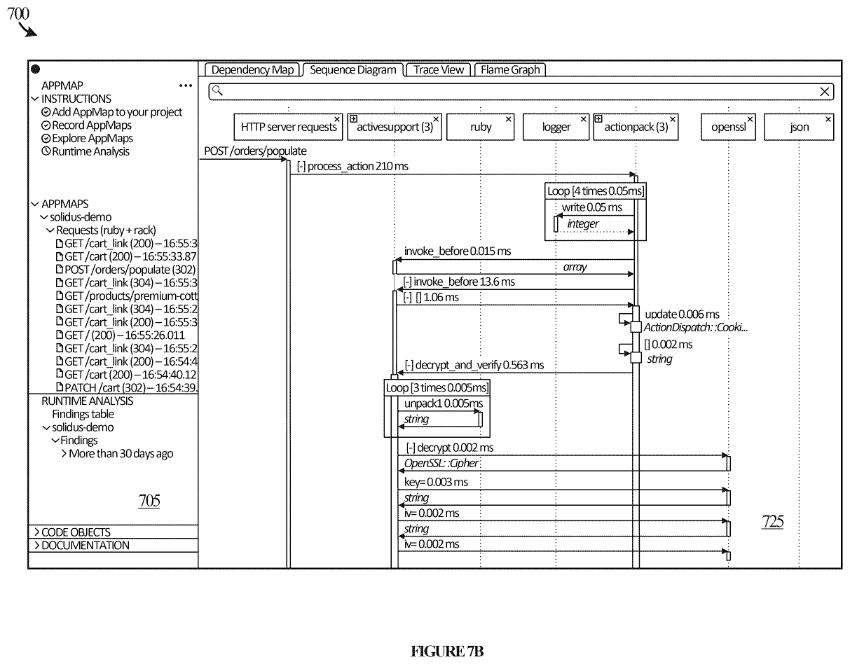

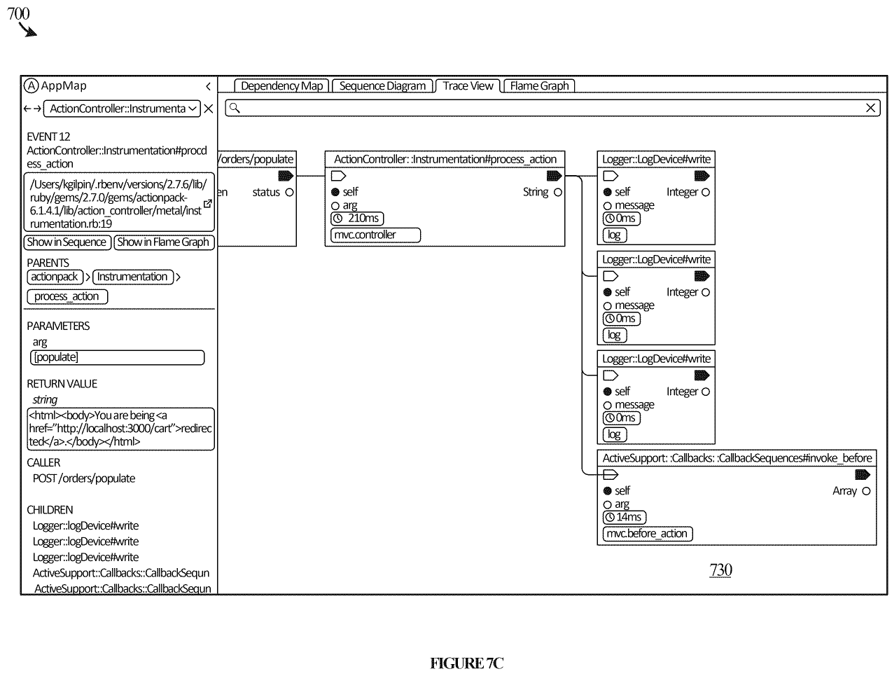

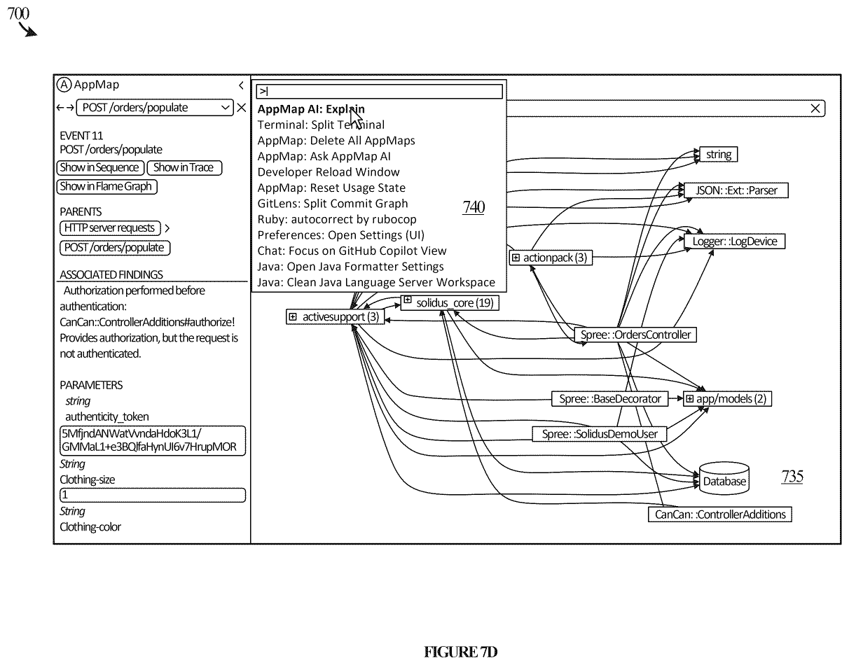

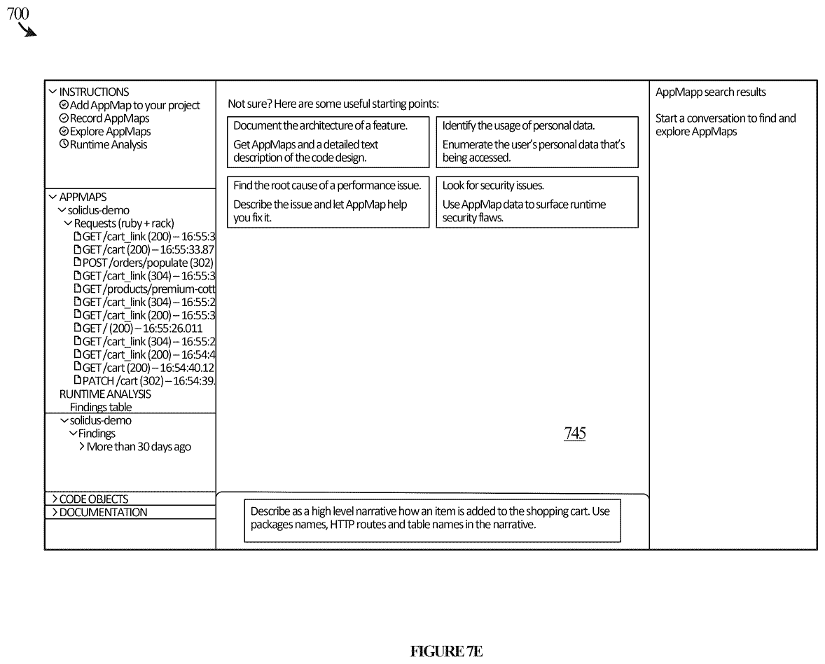

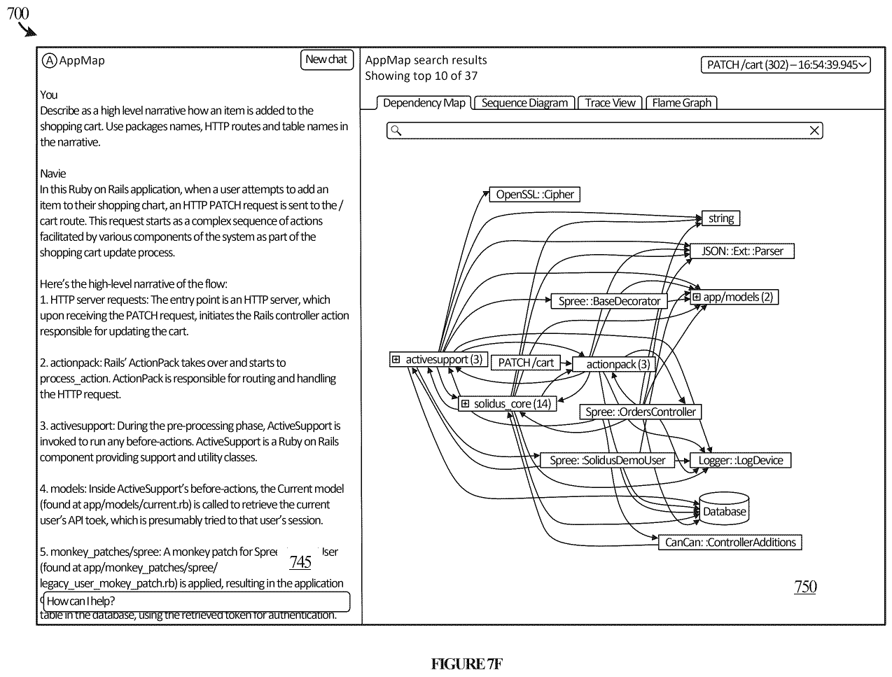

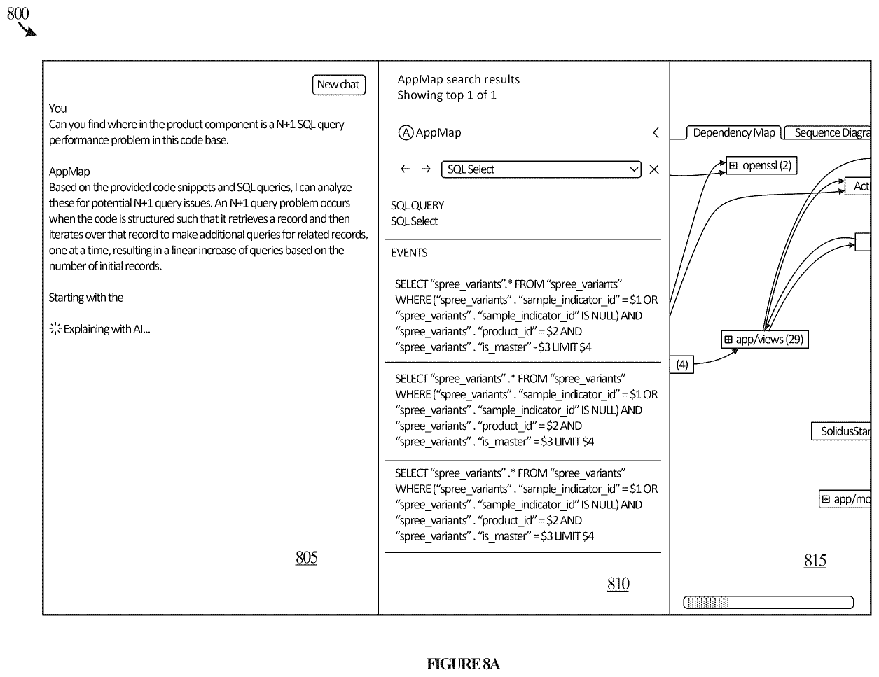

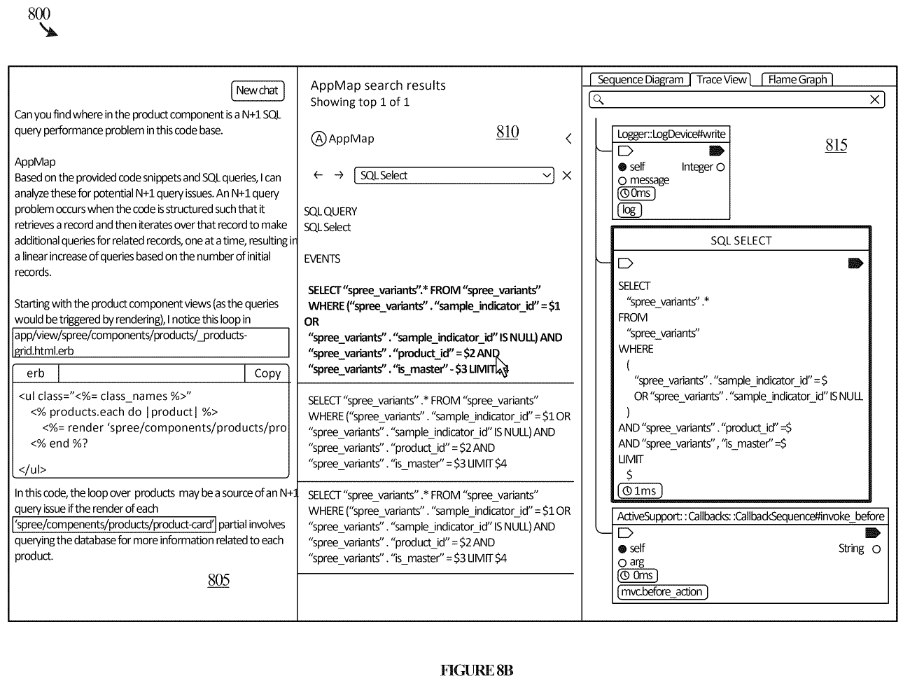

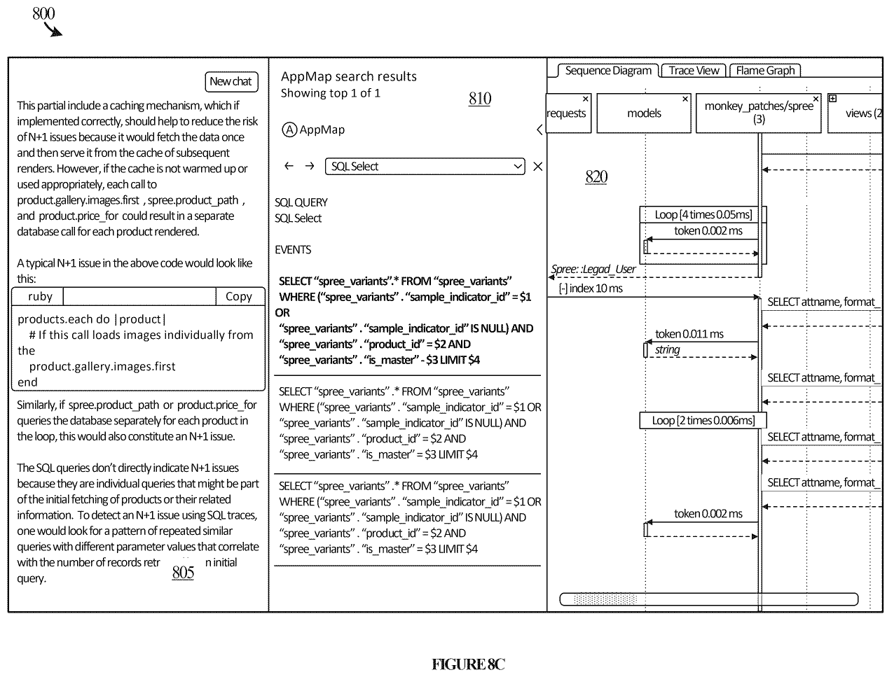

FIG. 7A depicts user interface 700, of which user interface 131 of FIG. 1 is representative, of an application hosted by a system for analyzing a codebase and resolving user queries regarding the codebase, of which system 160 is representative. User interface 700 includes a menu listing 705 that includes an expandable listing of data related to the codebase (e.g., codebase 111). Menu listing 705 is generated by analyzing the behavioral model that exposes data about the codebase including the methods and objects used and generated in the codebase. User interface 700 also includes code viewer 710 that depicts selected code snippets for viewing, modifying, and executing. User interface 700 also includes server information 715 which depicts the server information and behavior of the server executing the code when the codebase is executed. In user interface 700, browser window 720 is generated by executing the codebase. In this way, the user can execute the codebase and step through and perform actions as an end user. As the user executes the codebase, the system records the execution and generates trace files which reflect the operation of various processes and functionalities the codebase, such as code paths and other run-time event data. The trace files are stored for analysis. In some embodiments, the trace files are the behavioral model. In some embodiments, the trace files are analyzed and stitched together intelligently to generate the behavioral model. The behavioral model can then be processed to provide information about the codebase and the behavior of the codebase in visual ways shown in FIGS. 7A-7F and 8A-8C.

FIG. 7B depicts the user interface showing menu listing 705, and the user has made selections to show the generated behavioral model in sequence listing 725. Sequence listing 725 is a visual representation of the behavioral model including graphical elements which describe the operation of the codebase. The user may select an element in a particular sequence to learn more about a process, a functionality, or other aspect of the codebase. For example, the user may select a graphical element of sequence listing 725 and submit a natural language query about the section of the codebase associated with the element. The system hosting user interface 700 may then configure a prompt for a foundation model including the query, the relevant location(s), of the behavioral model, and the lines of code associated with the selected element to receive an AI-generated response including a resolution of the query in accordance with the technology disclosed herein.

FIG. 7C illustrates user interface 700 with the behavioral model visually depicted in trace view 730, which is similar to the visual depiction 300 of FIG. 3. In trace view 730, the user can select elements within the visual representation to expand or collapse particular areas for drilling into behaviors of the codebase As with sequence listing 725 of FIG. 7B, the user can select a graphical element of trace view 730 and submit a natural language query about the section of the codebase associated with the element. The system may then configure a prompt for a foundation model including the query, the relevant location(s), of the behavioral model, and the lines of code associated with the selected element to receive an AI-generated response including a resolution of the query in accordance with the technology disclosed herein.

FIG. 7D illustrates user interface 700 with the behavioral model visually depicted in a dependency map 735. Further, the user has expanded popup window 740 and is selecting highlighted entry for entering a user query about the codebase represented in dependency map 735. As with sequence listing 725 of FIG. 7B, the user can select a graphical element of dependency map 735 and submit a natural language query about the section of the codebase associated with the element. The system may then configure a prompt for a foundation model including the query, the relevant location(s), of the behavioral model, and the lines of code associated with the selected element to receive an AI-generated response including a resolution of the query in accordance with the technology disclosed herein.

FIG. 7E illustrates user interface 700 after selection of the highlighted entry from FIG. 7D. A chat window 745 opens and the user enters a query in the text box. In this case, the query states: “Describe as a high level narrative how an item is added to the shopping cart. Use package names, HTTP routes, and table names in the narrative.” Note that the codebase depicted in this example is a shopping cart application. Accordingly, the user query is asking how the code adds an item to the shopping cart, wants the response to use codebase specific elements (e.g., HTTP routes), and also wants a narrative response that a person can understand. Chat window 745 also includes sample user queries including more general inquiries about the codebase. The sample queries may be generated by the AI model in response to a prompt from the system where the prompt includes information relating to the user's recent activity in the application (e.g., portions of the behavioral model viewed, portions of the codebase viewed).

FIG. 7F illustrates user interface 700 with chat window 745 depicting the elicited response to the query depicted in FIG. 7E. To generate the response, the system used the previously generated behavioral model. An interrogation module of the system interrogated the behavior model to identify trace files related to adding an item to a shopping cart and identified the relevant code snippets. Then a resolution module of the system used the query, the relevant trace files, and the code snippets to design a prompt that elicited the depicted response. In view 750, the system displays a visual representation of a portion of the behavioral model which relates to the response. To configure view 750, the system may parse the response to identify references to portions of the behavioral model to depict. The system may also select the particular type of visual representation (e.g., dependency map, sequence listing) based on information in the response or on a classification of the user query. For example, in some scenarios, the prompt may task the foundation model with selecting a type of visual representation to display in association with the response.

Notably, in user interface 700, the user may select a graphical element of view 750 to submit a follow-on query, such as a request for more detailed information about the code associated with the element. When the system configures a prompt for the foundation model, the portion of the codebase associated with the selection is included in the prompt. Similarly, the user may select a portion of the response displayed in chat window 745 and submit a follow-on query in association with the selection. In either case, the selected content and the previous information exchange between the system and foundation model is included in the prompt to provide context for the model in generating its response to the follow-on query.

FIG. 8A illustrates user interface 800 with chat window 805 depicting a question submitted by the user and a response generated by the foundation model based on a prompt designed by a resolution module of the system. In this case, the user query states “Can you find where in the product component is a N+1 SQL query performance problem in this case base.” An interrogation module of the system interrogates the behavioral model of the relevant codebase and identifies trace files relating to SQL queries according to a search based on the user query. The interrogation module then identifies and extracts relevant code snippets from the identified trace files and provides them to the resolution module. The resolution module populates the prompt with the user query, the identified trace files, and the code snippets. The beginning of the response is shown in chat window 805. As shown in code view 810, particular SQL queries can quickly be found. In some embodiments, the resolution module can utilize the interrogation module to find the particular portions of the codebase based on the response and modify the code view to zoom to the particular code snippets related to the response.

FIG. 8B illustrates user interface 800 with chat window 805 depicting more of the response. Further, the user may select a code snippet in code view 810 to zoom to a particular related location in trace view 815 of the behavioral model. In order to create the link between the code view and the behavioral model, tags may be located within the codebase and the behavioral model during behavioral model generation to link particular portions of the codebase to particular locations within the behavioral model (e.g., according to line numbers of the source code).

FIG. 8C illustrates user interface 800 with chat window 805 depicting still more of the response. Further, the user may have modified trace view 815 (shown in FIG. 8B) to view sequence view 820 of the behavioral model, an alternative visual representation of the behavioral model. Sequence view 820 shows where the particularly requested information resides within the visual representation.

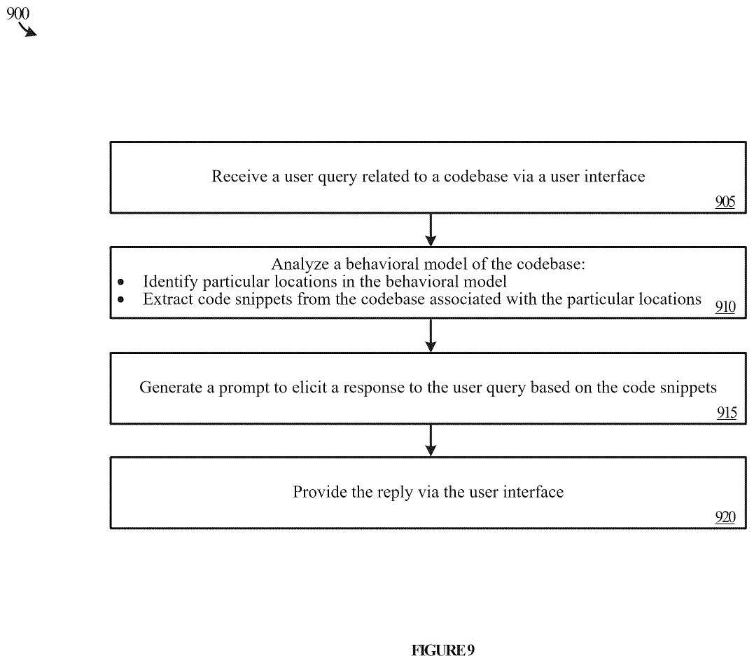

FIG. 9 illustrates process 900 for resolving user queries using behavioral model analysis and foundation model interaction. Process 900 includes receiving a user query related to a codebase via a user interface (905). For example, the user may utilize user interface 131 to upload a codebase, request a behavioral model, and during analysis ask a particular question about the codebase. See, for example, questions used in user interface 700 and 800. Process 900 further includes analyzing a behavioral model of the codebase, including identifying particular locations in the behavioral model and extracting code snippets from the codebase associated with the particular locations (910). For example, resolution module 120 may receive the user query and send it to interrogation module 115 to analyze behavioral model 113 to identify locations within the behavioral model that are related to the user query. Once the behavioral model locations are identified, interrogation module 115 can find the associated locations within the codebase and extract code snippets from the locations within the codebase. Interrogation module 115 can provide the code snippets back to resolution module 120.

Process 900 further includes generating a prompt to elicit a response to the user query based on the code snippets (915). For example, resolution module 120 designs a prompt for foundation model 150 that requests a response to the user query and provides the code snippets for use in generating the response. Process 900 further includes providing the reply via the user interface (920). For example, resolution module 120 receives the response and provides it via, for example, the chat window (e.g., chat window 805) used to submit the user query. In some embodiments, the response can be audibly provided instead of or in addition to visually.

Process 900 may include more or fewer steps as discussed throughout. Further, the order of the steps may be performed differently than depicted.

FIG. 10 illustrates computing device 1001 that is representative of any system or collection of systems in which the various processes, programs, services, and scenarios disclosed herein may be implemented. Examples of computing device 1001 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof. Computing device 1001 may be device 200, user equipment 330, computing devices that implement cloud services including behavioral model generator 110, interrogation module 115, resolution module 120 interface 105 or storage 140, a computing device that implements user interface 700 and 800, or a computing device that implements workflow 600 or process 900.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements user query resolution process 1006, which includes the behavioral model generation (e.g., behavioral model generator 110, behavioral model generator 223) of a codebase (e.g., codebase 111, 211, 305), the behavioral model interrogation (e.g., interrogation module 115, interrogation module 225) to identify the relevant portions of the behavioral model and associated code snippets, and the resolution response to the user query (e.g., responses provided by resolution module 120, 227). When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise any type of processor (e.g., a micro-processor) and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. In other words, the computer readable storage media is a non-transitory computer readable media.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or other systems.

Software 1005 (including user query resolution process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing a multipoint format process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to support the described processes for resolving user queries based on analysis of a behavioral model of the codebase (e.g., process 400, workflow 600, process 900). Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computer-implemented method, comprising:
receiving, via a user interface, a user query related to a codebase;
analyzing a behavioral model of the codebase, wherein the behavioral model represents a run-time behavior of the codebase generated based on a run-time analysis of the codebase, and wherein the analyzing comprises:
identifying content of the behavioral model associated with the user query, and
extracting code snippets from the codebase associated with the content of the behavioral model;
generating a prompt to elicit a reply from a foundation model, wherein the prompt tasks the foundation model with generating an answer for the user query and wherein the prompt includes the content of the behavioral model and the code snippets; and
causing display of the reply in the user interface.

2. The computer-implemented method of claim 1, wherein identifying the content of the behavioral model comprises:
generating a keyword list based on the user query; and
searching the behavioral model for locations in the behavioral model associated with the user query based on the keyword list.

3. The computer-implemented method of claim 2, wherein generating the keyword list comprises generating a second prompt to elicit a second reply from the foundation model, wherein the second prompt tasks the foundation model with generating the keyword list based on the user query.

4. The computer-implemented method of claim 2, wherein searching the behavioral model for the locations in the behavioral model associated with the user query comprises performing a text similarity search of the behavioral model based on the keyword list.

5. The computer-implemented method of claim 2, wherein extracting the code snippets from the codebase further comprises identifying portions of the codebase according to a text similarity search of the codebase based on the keyword list.

6. The computer-implemented method of claim 1, wherein receiving the user query related to the codebase further comprises:
receiving user input comprising a selection of a portion of the codebase; and
based on the selection of the portion of the codebase, causing display of a chat pane in the user interface by which to receive the user query.

7. The computer-implemented method of claim 1, further comprising causing display of a portion of the codebase in a visual representation of the behavioral model in the user interface based on the reply.

8. The computer-implemented method of claim 1, further comprising causing display of a portion of the behavioral model in a visual representation of the behavioral model based on a classification of the user query.

9. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive, via a user interface, a user query related to a codebase;
analyze a behavioral model of the codebase, wherein the behavioral model represents a run-time behavior of the codebase generated based on a run-time analysis of the codebase, and wherein the analyzing comprises:
identifying content of the behavioral model associated with the user query, and
extract code snippets from the codebase associated with the content of the behavioral model;
generate a prompt to elicit a reply from a foundation model, wherein the prompt tasks the foundation model with generating an answer for the user query and wherein the prompt includes the content of the behavioral model and the code snippets; and
cause display of the reply in the user interface.

10. The computing apparatus of claim 9, wherein to identify the content of the behavioral model, the program instructions direct the computing apparatus to:
generate a keyword list based on the user query; and
search the behavioral model for locations in the behavioral model associated with the user query based on the keyword list.

11. The computing apparatus of claim 10, wherein generating the keyword list comprises generating a second prompt to elicit a second reply from the foundation model, wherein the second prompt tasks the foundation model with generating the keyword list based on the user query.

12. The computing apparatus of claim 10, wherein searching the behavioral model for the locations in the behavioral model associated with the user query comprises performing a text similarity search of the behavioral model based on the keyword list.

13. The computing apparatus of claim 10, wherein extracting the code snippets from the codebase further comprises identifying portions of the codebase according to a text similarity search of the codebase based on the keyword list.

14. The computing apparatus of claim 9, wherein receiving the user query related to the codebase further comprises:
receiving user input comprising a selection of a portion of the codebase; and
based on the selection of the portion of the codebase, causing display of a chat pane in the user interface by which to receive the user query.

15. The computing apparatus of claim 9, further comprising causing display of a portion of the codebase in a visual representation of the behavioral model in the user interface based on the reply.

16. The computing apparatus of claim 9, further comprising causing display of a portion of the behavioral model in a visual representation of the behavioral model based on a classification of the user query.

17. A system, comprising:
a behavioral model generator configured to execute a codebase to generate a behavioral model, the behavioral model generator comprising first program instructions that cause one or more processors to:
generate the behavioral model of the codebase, wherein the behavioral model represents a run-time behavior of the codebase generated based on a run-time analysis of the codebase;
an interrogation module configured to interrogate the behavioral model, the interrogation module comprising second program instructions that cause a second one or more processors to:
identify content of the behavioral model associated with a user query, and
extract code snippets from the codebase associated with the content of the behavioral model;
a resolution module configured to generate a prompt to elicit a reply from a foundation model, the resolution module comprising third program instructions that cause a third one or more processors to:
generate the prompt to elicit a reply from the foundation model, wherein the prompt tasks the foundation model with generating an answer for the user query and wherein the prompt includes the content of the behavioral model and the code snippets; and
a user interface component comprising fourth program instructions that cause a fourth one or more processers to:
receive, via a user interface, the user query related to the codebase; and
cause display of the reply in the user interface.

18. The system of claim 17, wherein to identify the content of the behavioral model, the second program instructions direct the second one or more processors to:
generate a keyword list based on the user query; and
search the behavioral model for locations in the behavioral model associated with the user query based on the keyword list.

19. The system of claim 18, wherein to generate the keyword list based on the user query, the second program instructions direct the second one or more processors to generate a second prompt to elicit a second reply from the foundation model, wherein the second prompt tasks the foundation model with generating the keyword list based on the user query.

20. The system of claim 18, wherein to search the behavioral model for the locations in the behavioral model associated with the user query, the second program instructions direct the second one or more processors to perform a text similarity search of the behavioral model based on the keyword list.
